(19) United States
(12) Patent Application Publication
(10) Pub. No.: US 2015/0223201 A1
(43) Pub. Date: Aug. 6, 2015

(54) METHOD AND APPARATUS FOR PROVIDING POINT OF INTEREST INFORMATION ASSOCIATED WITH BROADCAST CONTENT

(71) Applicant: Nokia Corporation, Espoo (FI)

(72) Inventors: Dhaval Jitendra Joshi, Bangalore (IN); Ari Antero Aarnio, Espoo (FI)

(21) Appl. No.: 14/421,780

(22) PCT Filed: Sep. 25, 2013
(86) PCT No.: PCT/FI2013/050930

§ 371 Date: Feb. 13, 2015

(30) Foreign Application Priority Data
Oct. 5, 2012 (IN) 4166/CHE/2012

(51) Int. Cl. H04W 72/00; H04H 60/70; H04H 60/61; H04W 4/02

(52) U.S. Cl. CPC H04W 72/005; H04W 4/025; H04H 60/70; H04H 60/61

(57) ABSTRACT

An approach is provided for transmitting point of interest information associated with a network broadcast. A point of interest platform receives, at a device, a program item over a network broadcast. Then, the point of interest platform processes and/or facilitates a processing of the data carrier signal associated with the broadcast content to determine the point of interest information associated with the program item.

### BACKGROUND

Service providers and device manufacturers (e.g., wireless, cellular, etc.) are continually challenged to deliver value and convenience to consumers by, for example, providing compelling network services. One area of development has been in advertisement wherein radio services are being utilized to broadcast point of interest information. However, due to audio nature of the information, a user needs to remember the information received, making it potentially difficult to correlate the broadcasted point of interest information with the real life point of interest. Accordingly, service providers and device manufacturers face significant technical challenges to provide audio point of interest information over a broadcast content in a way that users can easily relate to the real life point of interest.

### SOME EXAMPLE EMBODIMENTS

Therefore, there is a need for an effective and efficient approach for processing a data carrier signal associated with a broadcast content to determine point of interest information, and transmit the determined point of interest information in a map readable format, where it is presented with the linked point of interest as visual guidance information to users.

According to one embodiment, a method comprises receiving, at a device, at least one program item over at least one network broadcast. The method also comprises processing and/or facilitating a processing of at least one data carrier signal associated with the at least one network broadcast to determine point of interest information associated with the at least one program item.

According to another embodiment, an apparatus comprises at least one processor, and at least one memory including computer program code for one or more computer programs, the at least one memory and the computer program code configured to, with the at least one processor, cause, at least in part, the apparatus to receive, at a device, at least one program item over at least one network broadcast. The apparatus is also caused to process and/or facilitate a processing of at least one data carrier signal associated with the at least one network broadcast to determine point of interest information associated with the at least one program item.

According to another embodiment, a computer-readable storage medium carries one or more sequences of one or more instructions which, when executed by one or more processors, cause, at least in part, an apparatus to receive, at a device, at least one program item over at least one network broadcast. The apparatus is also caused to process and/or facilitate a processing of at least one data carrier signal associated with the at least one network broadcast to determine point of interest information associated with the at least one program item.

According to another embodiment, an apparatus comprises means for receiving, at a device, at least one program item over at least one network broadcast. The apparatus also comprises means for processing and/or facilitating a processing of at least one data carrier signal associated with the at least one network broadcast to determine point of interest information associated with the at least one program item.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of processing a data carrier signal associated with a broadcast content to determine point of interest information, and transmit the determined point of interest information in a map readable format, according to one embodiment;

FIG. 2 is a diagram of the components of point of interest platform, according to one embodiment;

FIG. 3 is a diagram of the components of processing module, according to one embodiment;

FIG. 4 is a diagram of a geographic database, such as can be included in the system of FIG. 1, according to one embodiment;

FIG. 5 is a flowchart of a process for receiving a program item over a network broadcast and processing and/or facilitating a processing of data carrier signal associated with the broadcast content to determine a point of interest information, according to one embodiment;

FIG. 6 is a flowchart of a process for presenting the point of interest information, determining an expiration time for the point of interest, and then causing a validation or a storage of the point of interest information, according to one embodiment;

FIG. 7 is a flowchart of a process for causing an update of at least one geographic database and point of interest, determining one or more hyper links to information associated with the program item, and causing a filtering of the point of interest information, according to one embodiment;

FIG. 8 is a diagram of one or more user interfaces utilized in the process of FIGS. 5-7, according to various embodiments;

FIG. 9 is a diagram of one or more user interfaces utilized in the process of FIGS. 5-7, according to various embodiments;

FIG. 10 is a diagram of one or more user interfaces utilized in the process of FIGS. 5-7, according to various embodiments;

FIG. 11 is a diagram of one or more user interfaces utilized in the process of FIGS. 5-7, according to various embodiments;

FIG. 12 is a diagram of hardware that can be used to implement an embodiment of the invention;

FIG. 13 is a diagram of a chip set that can be used to implement an embodiment of the invention; and

FIG. 14 is a diagram of a mobile terminal (e.g., handset) that can be used to implement an embodiment of the invention.

### DESCRIPTION OF SOME EMBODIMENTS

Examples of a method, apparatus, and computer program for processing a data carrier signal associated with a network broadcast to determine point of interest information, and transmit the determined point of interest information in a map readable format are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

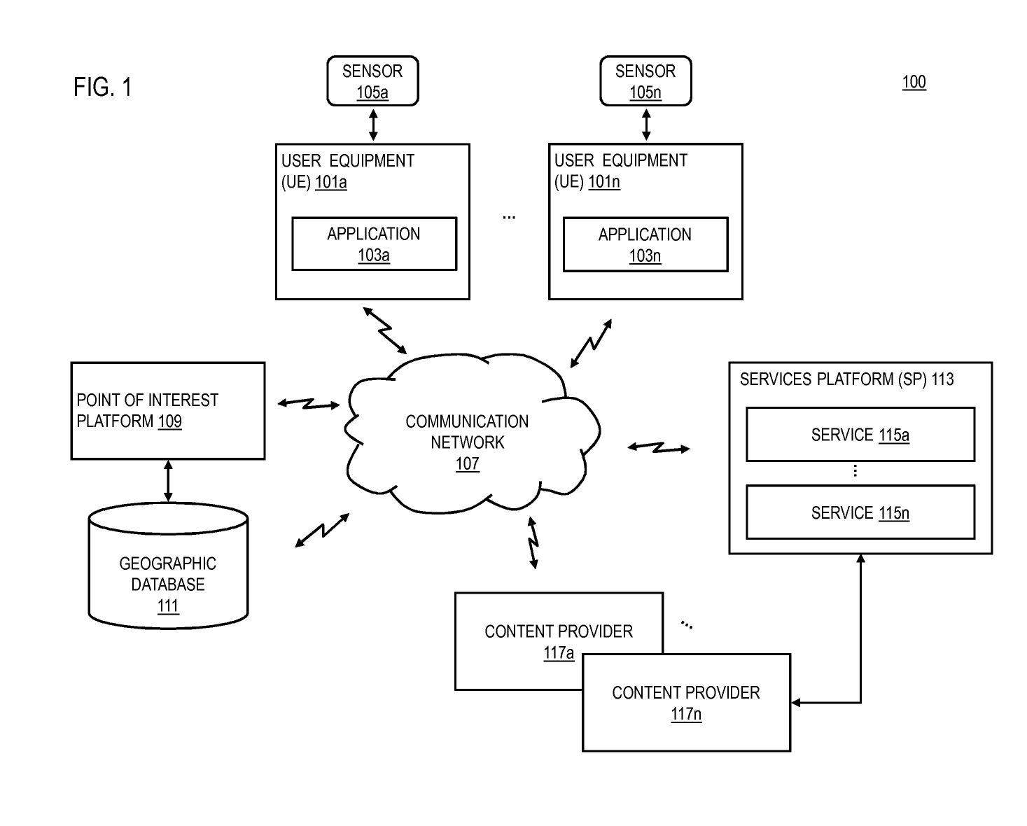

FIG. 1 is a diagram of a system capable of receiving, at a device, at least one program item over at least one network broadcast and processing a data carrier signal associated with a broadcast content to determine point of interest information, according to one embodiment. The service providers and device manufacturers (e.g., wireless, cellular, etc.) are continually challenged to provide compelling network services, that may include, transmission services that enables transmission of an aural point of interest information associated with a program item over a broadcast content to a map readable format and then plot the point of interest information on a mapping user interface for visual display, upon determination of an association of point of interest information with UE 101 registered with the point of interest platform 109. As mentioned, one big challenge with the network broadcast information is that, due to audio nature of the information, the users must remember the information received. For example, to associate an audio advertisement with a point of interest, the users should remember the name of the point of interest and maybe the address, and then use a location based service to find out the location of the point of interest. In addition, the problem of correlating the audio information with a mapped point of interest and then to its real life counterpart multiplies where there is numerous point of interest in a small geographic area. Further, the cognitive load for remembering the information and reading or scanning through point of interest can quickly increase as the speed of travel increases. Other factors, such as the volume of information for a point of interest, the complexity of the information for a point of interest, the speed of the audio advertisements etc. can also present significant strains on the user's cognitive load, thereby making the linking of an audio point of interest information with its real life counterpart, potentially taxing and difficult.

To address these issues, a system 100 of FIG. 1 introduces the capability to provide a transmission of aural point of interest information into map readable format. In one embodiment, the system 100 makes the identification of a point of interest (e.g., a place, building, location, etc. associated with the point of interest) easier by providing visual representation of an aural points of interest information with a point of interest. For example, the audio point of interest information can be determined based on location information (e.g., proximity information, historical user information, predicted user information, contextual information, location-based content information etc.) associated with the UE 101. In this way, the system 100 can present a visual representation of aural point of interest information on a mapping user interface of UE 101, to enable a user to identify the point of interests in the real life environment just by looking at the map user interface. For example, XYZ shop is a popular franchise and there are five XYZ shop in one congested town, and one of those XYZ shop is offering 50% discount on all items. If a user tune into a radio station to listen to music or some other forms of entertainment shows and happens to hear a radio broadcast which states “XYZ shop in this town is offering 50% discount on all items”, the user may be confused because the mapping device shows five XYZ shops in the location. Therefore, whenever an audio advertisement is played, the point of interest platform 109 may receive at least one program item over at least one radio broadcast. The point of interest platform 109 may process and/or facilitate a processing of at least one data carrier signal associated with network broadcast to determine point of interest information associated with the at least one program item. The point of interest information is then transmitted to map readable format and is plotted in the map for usage.

In one embodiment, the system 100 may process the content information (e.g., one or more geo-routes, one or more location anchors, etc.) associated with UE 101 to determine point of interest information associated with the at least one program item over a network broadcast, to cause a generation of a presentation of such information with the point of interest in a mapping device. The system 100 may then determine a service for presenting the point of interest information, and transmit the information to the service. By way of example, the system 100 may transmit point of interest information from a network broadcast, wherein the point of interest information is associated with the location information of UE 101 registered with the point of interest platform 109, for instance, based on historical user information, such as, the number of times a particular location was visited by the user of UE 101, the point of interest platform 109 may determine point of interest information.

For example, the presentation of the point of interest information with the point of interest in a mapping device helps users to identify the point of interest simply by looking at the map and scanning the surrounding if needed, rather than listening to the information on a radio broadcast, remembering the information and associating the audio annotations with the point of interest in the mapping device, hence, making it easier to spot the destination. In this way, the system 100 resolves problems associated with typical broadcast content and navigation services, for example, by allowing an association of point of interest information associated with the at least one program item over network broadcast with the point of interest and, thus, providing an approach for easy and speedy way-finding techniques.

As shown in FIG. 1, the system 100 comprises user equipment (UE) 101a-101n (collectively referred to as UE 101) that may include or be associated with applications 103a-103n (collectively referred to as applications 103) and sensors 105a-105n (collectively referred to as sensors 105). In one embodiment, the UEs 101 have connectivity to a point of interest platform 109 via the communication network 107. In one embodiment, the point of interest platform 109 performs one or more functions associated with transmitting aural points of interest information associated with the received program item over network broadcast, and causes a presentation with the points of interest associated with UE 101, for instance, in conjunction with the applications 103 and/or related services 115a-115n of the services platform 113. By way of example, the applications 103 may be any type of application that is executable at the UE 101, such as mapping applications, navigation applications, and/or any other applications that may use point of interest information including general applications such as media player applications, social networking applications, calendar applications, content provisioning services, and the like. In one embodiment, one of the applications 103 at the UE 101 may act as a client for point of interest platform 109 and perform one or more functions associated with the functions of the point of interest platform 109. In addition, the sensors 105 may be any type of sensor. In one embodiment, the sensors 105 may include one or more sensors that may assist the point of interest platform 109 to determine an audio point of interest information to be used with a point of interest associated with UE 101. In one scenario, the sensors 105 may include location sensors (e.g., GPS), light sensors, moisture sensors, pressure sensors, audio sensors (e.g., microphone), or receivers for different short-range communications (e.g., Bluetooth, WiFi, etc.).

By way of example, the UE 101 is any type of mobile terminal, fixed terminal, or portable terminal including a mobile handset, station, unit, device, multimedia computer, multimedia tablet, Internet node, communicator, desktop computer, laptop computer, 4G phones, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the point of interest platform 109 may include or have access to a geographic database 111 to access or store any kind of data associated with a point of interest, such as historical user information, location proximity information, temporal proximity information, contextual proximity information, etc. Data stored in the geographic database 111 may, for instance, be provided by the UEs 101, a service platform 113, one or more services 115a-115n (or services 115), or one or more content providers 117a-117n (or content providers 117).

In one scenario, for instance, a UE 101 receives a radio broadcast that XYZ restaurant is offering discounts. The user of the UE 101 wants to visit XYZ shop (e.g., a point of interest). As such, the user may use his mobile phone to access navigation services while driving to XYZ shop. In this example, the user needs to remember the point of interest information broadcasted, such as, the name and the location of the point of interest. The user then needs to enter this information in a location based service to find out the direction of the point of interest. Such manual process of entering the data is tedious and time consuming, especially if a user is driving. In various embodiments, the system 100 (e.g., via a point of interest platform 109) may receive a program item over a network broadcast and may process such data carrier signal associated with the broadcast content to determine point of interest information associated with the at least one program item. The determined point of interest information is then transmitted in a map readable format as part of the point of interest for presentation to the user. In this way, a navigation service may present the user with textual or pictorial representation of the point of interest information alongside the point of interest as visual guidance when displaying mapping and/or navigation information.

As noted previously, the textual or pictorial representation of point of interest information acts as visual guidance to the user when he is looking around his real life environment to spot the point of interest. In this example, if XYZ shop is offering 25% discount on all electronic devices, the system 100 renders the point of interest information in association with the point of interest in the user interface of the navigation service. In many situations, it is easier for the user to quickly identify the point of interest by looking at the mapping device with the information displaying next to the point of interest as opposed to listening and then entering the point of interest information. This ease of identification is particularly helpful when the user is driving.

In one embodiment, the point of interest platform 109 may be a platform with multiple interconnected components. The point of interest platform 109 may include multiple servers, intelligent networking devices, computing devices, components and corresponding software for performing the function of transmitting a point of interest information associated with the received program item over network broadcast, for instance, by providing a textual representation for the aural point of interest information in a mapping device as visual guidance information to the users. In addition, it is noted that the point of interest platform 109 may be a separate entity of the system 100, a part of the one or more services 115 of the service platform 113, or included within the UE 101 (e.g., as part of the application 103). The point of interest platform 109 may store a set of inherent set rules for transmitting various aural point of interest information to UE 101. A typical transmission is the linking of certain broadcasted point of interest information with UE 101. For example, a very prominent point of interest, XYZ restaurant, can be linked with the radio point of interest information, such representation reflects the broadcasted information for the point of interest and the user can easily associate with such visual representation of the audio advertisement that has been extracted from radio advertisement and presented in a visual format.

In one embodiment, the point of interest platform 109 may cause, at least in part, an enabling of the presentation of point of interest information alongside the point of interest, on determining the point of interest information upon processing of the at least one data carrier signal associated with the network broadcast. As indicated in the above scenario, a user may want to visit point of interest (e.g., XYZ shop) in lieu of the radio broadcast. The point of interest information flow may be sent over on a Radio Data System (RDS) protocol and/or a Radio Broadcast Data System (RBDS) protocol, as carrier to UE 101. The UE 101 then sends a request to the point of interest platform 109 for transmitting the point of interest in a map readable format. The point of interest platform 109 communicates with the geographic database 111, the services platform 113 and the content provider 117 for relevant point of interest information. The point of interest platform 109 then processes data carrier signal associated with the broadcast content to determine point of interest information. Upon determination, the point of interest platform may initiate one or more applications for presenting the point of interest information, wherein the point of interest information is transmitted in a map readable format and plotted on a mapping user interface.

In one embodiment, Radio data system (RDS) and/or a Radio Broadcast Data System (RBDS) protocol may be a radio standard used for sending small amounts of digital information using conventional FM radio broadcasts. The RDS system standardizes several types of information transmitted, including time and station identification. The use of more and more frequencies for radio programs in the FM range makes it increasingly difficult to tune to a desired program. This kind of difficulty is solved with RDS or RDBS system. The RDS or RDBS contains data about the frequencies of nearby transmitters and is able to automatically retune to the strongest signal without the need for action by the user. Generally, RDS or RDBS transmission involves combining a RDS or RDBS signal with a FM audio signal. The combined signal is used to modulate a FM transmitter which transmits an FM signal with the audio data and the RDS or RDBS information to a FM receiver. The RDS or RDBS receiver, or FM receiver capable of receiving an RDS or RDBS signal, receives and separates the RDS data from the FM audio data to allow the two types of information to be processed separately. The RDS or RDBS radio receivers on mobile communication devices are able to extract and use that data.

In another embodiment, wireless terminals such as mobile communication devices are able to provide FM radio reception. It is sought to provide a means whereby these technologies, RDS and/or RDBS and/or wireless terminals with FM radio reception can be advantageously used in conjunction with one another. One problem with broadcast content is that the listeners often fail to hear all information, for example if the listener is carrying out another task as well as listening, if the reception is poor or if the information is detailed and complex. A particular example of this is when a listener hears an advertisement on the radio but fails to hear the point of interest information or tune when it is announced. The broadcaster issues short radio text messages to RDS radio receivers using the RDS system. The radio text messages can then be displayed on the RDS radio receivers' visual display, such that, the point of interest is shown whilst that advertisement is broadcasted. However, one problem is that the listener may require more information than it is practical to include in the radio text message. In order to take such further actions that listener typically needs to re-enter the information to another system which is time consuming and complex. Therefore, the present invention relates to a method of accessing RDS information received from a network broadcast, processing them in order to determine whether or not to transmit them in map readable format for user access.

The services platform 113 may include any type of service. By way of example, the services platform 113 may include mapping services, navigation services, social networking services, content (e.g., audio, video, images, etc.) provisioning services, application services, storage services, contextual information determination services, location based services, information (e.g., weather, news, etc.) based services, etc. In one embodiment, the services platform 113 may interact with the UE 101, the point of interest platform 109 and the content providers 117 to supplement or aid in the processing of the content information. In other embodiments, the services platform 113, the services 115, the applications 103, etc. may be used to present the audio point of interest information associated with the received program item over network broadcast as visual guidance for users of UE 101.

By way of example, services 115 may be an online service that reflects interests and/or activities of users. In one scenario, the services 115 provide representations of each user (e.g., a profile), his/her social links, and a variety of additional information. The services 115 allow users to share location information, activities information, contextual information, historical user information and interests within their individual networks, and provides for data portability. The services 115 may additionally assist in providing the point of interest platform 109 with travel information of the one or more geo-routes and/or location anchors, etc.

The content providers 117 may provide content to the UE 101, the point of interest platform 109, and the services 115 of the services platform 113. The content provided may be any type of content, such as textual content, audio content, video content, image content, etc. In one embodiment, the content providers 117 may provide content that may supplement content of the applications 103, the sensors 105, or a combination thereof. By way of example, the content providers 117 may provide content that may aid in the processing of the content information associated with a point of interest to determine point of interest information associated with the received program item over network broadcast. In one embodiment, the content providers 117 may also store content associated with the UE 101, the point of interest platform 109, and the services 115 of the services platform 113. In one embodiment, the content providers 117 may manage access to a central repository of data, and offer a consistent, standard interface to data, such as a repository of users' navigational data content.

By way of example, the UE 101, the point of interest platform 109, the services platform 113, and the content providers 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

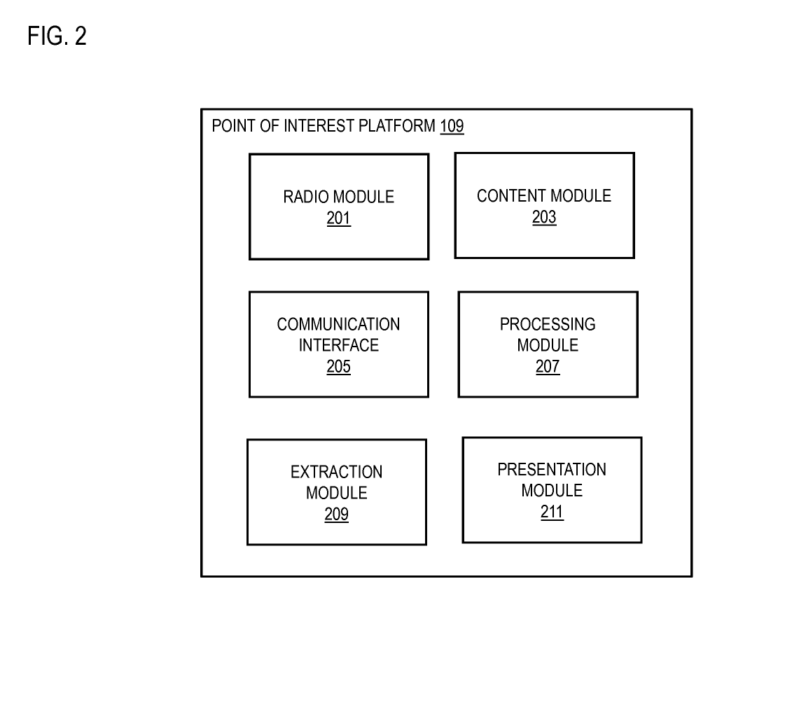

FIG. 2 is a diagram of the components of point of interest platform 109, according to one embodiment. By way of example, the point of interest platform 109 includes one or more components for providing a point of interest as visual guidance information to the users from radio advertisements. It is contemplated that the functions of these components may be combined in one or more components or performed by other components of equivalent functionality. In this embodiment, the point of interest platform 109 includes radio module 201, a content module 203, a communication interface 205, a processing module 207, an extraction module 209, and a presentation module 211.

The radio module 201 executes at least one algorithm for executing functions of the point of interest platform 109. For example, the radio module 201 may interact with the communication interface 205 to enable transmission of a radio point of interest information over the communication network 107 to the UE 101, the point of interest platform 109, the services platform 113, the services 115, the content providers 117, etc. The communication interface 205 may, for instance, execute various protocols and data sharing techniques for enabling collaborative execution between the UE 101, the point of interest platform 109, and services 113 over the communication network 107.

The radio module 201 may receive radio frequency broadcast wherein at least one data carrier signal is based, at least in part, on RDS and/or RBDS system and extracts the said RDS and/or RBDS information. The radio module 201 may also assist the processing module 207 to determine a point of interest for transmission from a radio advertisement. In addition, the presentation module 213 may work with the processing module 207 to cause a presentation of the point of interest based on a determination of a point of interest from a radio advertisement. In a particular example, a user listens to his favorite radio show on his mobile communication device with the help of radio module 201, and hears information on a car he wishes to purchase at a particular shop. The point of interest platform 109 is able to create a presentation containing RDS information which identifies the information on the car he wishes to buy and the shop that is selling the car based, at least in part, on the contextual information of UE 101. In this way a relationship is established between a network broadcast event and a customer. This provides advantages both for the end user, who is able to quickly, easily and effectively visit the point of interest to purchase the car, and also for the car sales entity, which is able to increase its volume of sales and to improve the speed and efficiency with which each sales transaction is made.

The content module 203 may assist the point of interest platform 109 to process the broadcasted point of interest information by collecting or determining content information associated with a point of interest for UE 101. In one embodiment, the content module 203 may determine content information from the applications 103 executed at the UE 101, the sensors 105 associated with the UE 101, and/or one or more services 115 on the services platform 113. In another embodiment, when the UE 101 sends a request for navigation services (e.g., point of interest information) to the point of interest platform 109, the content module 203 provides the point of interest platform 109 with the content information for determining a point of interest for extraction purposes (e.g., this process can also be complete prior to the request and then updated as needed to reflect new content information). The content information provided to the point of interest platform 109 can be, for example, geo-routes information, location anchors information, location proximity information, temporal proximity information, contextual proximity information, one or more content files, or a combination thereof.

In one embodiment, the content module 203 may track the geo-routes used by a UE 101 associated with the point of interest platform 109. In this manner, the statistical data that is obtained may be used for any suitable purpose, including the selection of point of interest from a radio advertisement for navigation purposes. The data may include, for example but not limited to, historical user information, ease of access information, predicted user information, etc.

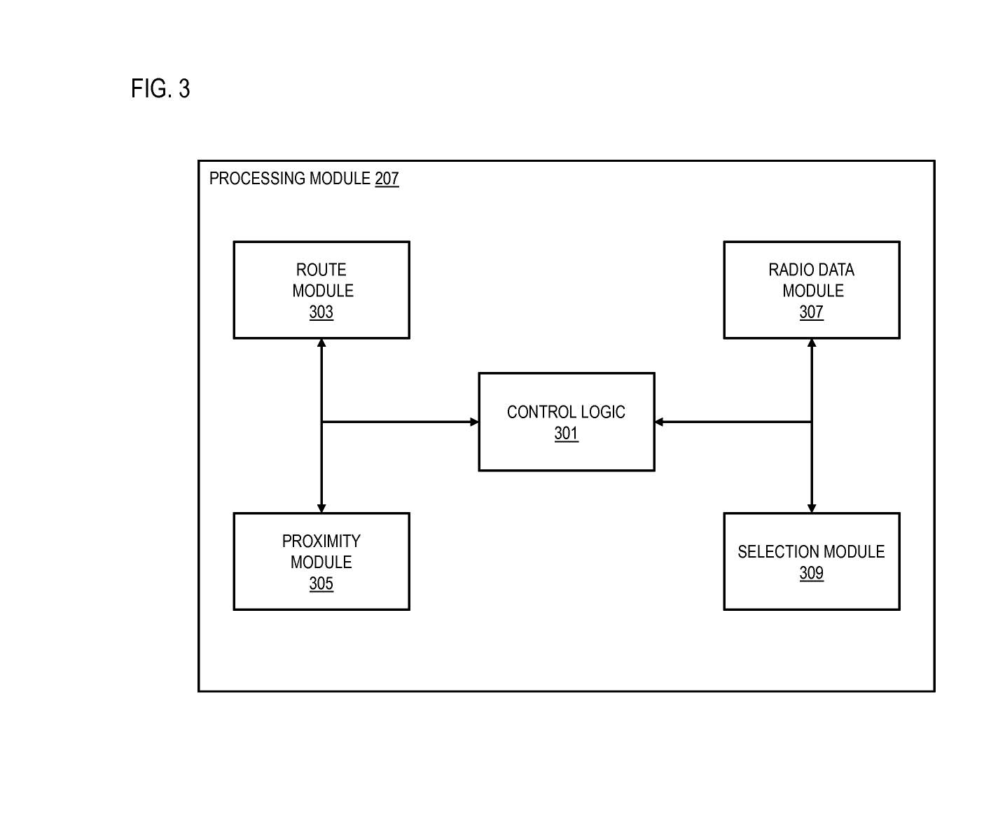

The processing module 207 enables the point of interest platform 109 to process the content information of UE 101 to determine (a) one or more broadcasted point of interest information associated with UE 101, (b) one or more geo-routes, the one or more location anchors, (c) one or more predicted locations, and (d) contextual information, user preference information, or a combination thereof associated with the one or more devices. The processing module 207 includes one or more modules that are executed in performing the processing, they are discussed in FIGS. 3.

The extraction module 209 extracts the point of interest information from a radio advertisement based on the content information of the one or more UE 101 associated with the point of interest platform 109, which are determined once the content information is processed by the processing module 207. As the content module 203 determines content information, the processing module 207 processes the content information. Next, the extraction module 209 extracts the point of interest information based, at least in part, on the travel pattern of UE 101. In one embodiment, the extraction module 209 extracts point of interest information from radio advertisements and associates them with the point of interest of UE 101. In another embodiment, the extraction module 209 may refrain from extracting a previously extracted point of interest unless there has been an update in the point of interest information. The extraction module 209 may replace the old point of interest information with the updated point of interest information. For instance, XYZ shop had summer sales last year, this information was extracted by the extraction module 209 and saved in the geographic database 111. The extraction module 209 may not extract the same information for XYZ shop again. However, if the information differs, such as “summer sales and 50% off on all shoes”, the extraction module 209 may extract the information and may replace the old point of interest information.

The presentation module 211 makes a presentation of the extracted information for a point of interest upon receiving the data from extraction module 209. The presentation module 211 may utilize the processing module 207 to determine whether the information for a point of interest is up to date. The module obtains a set of summary statistics from other modules. Then, the module continues with generating a presentation corresponding to the information. Then, continues with providing of presentation data set where the presentation could be depicted in one or more visual display units.

FIG. 3 is a diagram of the components of the processing module 207, according to one embodiment. By way of example, the processing module 207 includes one or more components for providing transmission of broadcasted point of interest information based on location information. It is contemplated that the functions of these components may be combined in one or more components or performed by other components of equivalent functionality. In this embodiment, the processing module 207 includes a control logic 301, route module 303, proximity module 305, radio data module 307, and selection module 309.

The control logic 301 executes at least one algorithm for executing functions at the presentation module 211. For example, the control logic 301 may interact with the route module 303 to receive one or more geo-routes, one or more location anchors, or a combination thereof associated with one or more UEs 101. In one embodiment, the route module 303 may determine one or more geo-routes, one or more location anchors, or a combination thereof using historical and/or predicted user information, such as the daily work commute traveled by one or more UEs 101. With the one or more geo-routes and/or one or more location anchors, the control logic 301 and the proximity module 305 may determine proximity information of one or more UEs 101 to one or more broadcasted point of interest information. The control logic 301 and the proximity module 305 may determine proximity information that includes, at least in part, location, temporal, contextual proximity information, or a combination thereof.

The control logic 301 and radio data module 307 may define broadcasted point of interest information, while the selection module 309 may select the broadcasted point of interest information based, at least in part, on the proximity information determined by the proximity module 305. For instance, the broadcasted point of interest information with one or more geo-routes and/or one or more location anchors within a certain proximity threshold of one or more UEs 101 may be selected out of all the broadcasted point of interest information. Alternately, the control logic 301 and selection module 309 may sort the one or more broadcasted point of interest information based on proximity information. For example in one scenario, the control logic 301 and selection module 309 may determine to select the top ten broadcasted point of interest information that is geographically closest to a UEs 101.

In one embodiment, the selection module 309 may select the one or more broadcasted point of interest information based, at least in part, on the location information. For instance, one or more broadcasted point of interest information may be selected because the history of geo-routes indicates that they will soon be proximate location (e.g., regardless of whether the UEs 101 are already in the location, as the predicted user information suggests that UEs 101 may soon be within the vicinity). Further, the selection module 309 may determine one or more predicted locations of a user based, at least in part, on the ease of access from a location associated with the UEs 101.

Further the selection module 309 may interact with content module 203 and extraction module 209 to direct the one or more UEs 101 to the determined broadcasted point of interest information. For example, the control logic 301 and application 103 may work together to determine navigation guidance information to cause, at least in part, a presentation of the one or more broadcasted point of interest information . In one scenario, this may include UEs 101 displaying directions on how to reach broadcasted point of interest information.

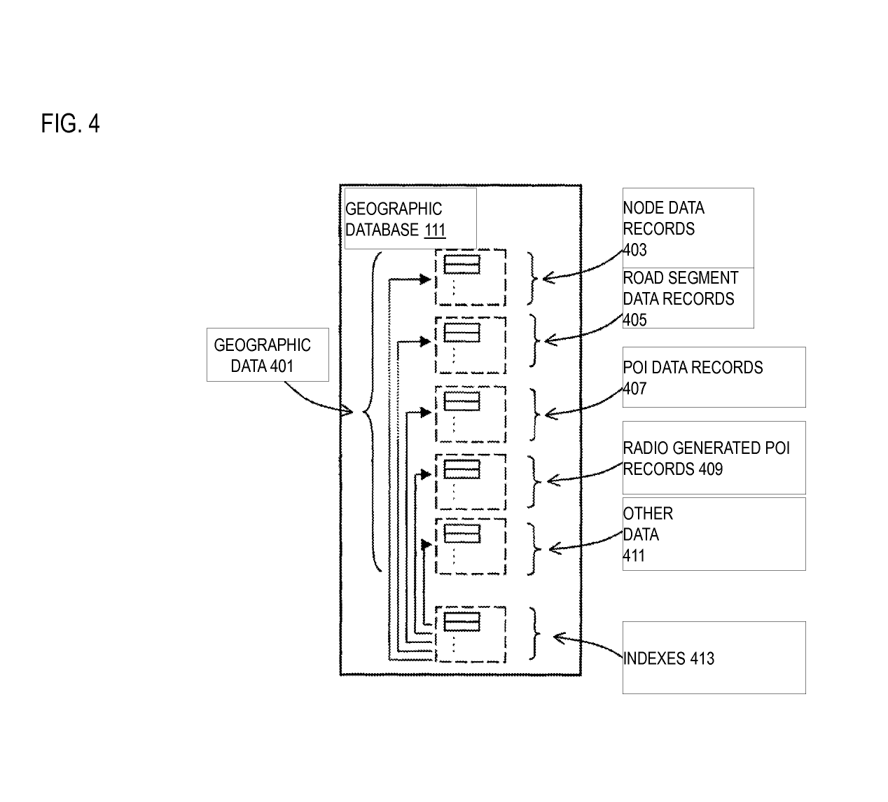

FIG. 4 is a diagram of geographic database 111 of system 100, according to exemplary embodiments. In the exemplary embodiments, POIs and radio generated POIs data can be stored, associated with, and/or linked to the geographic database 111 or data thereof. In one embodiment, the geographic or map database 111 includes geographic data 401 used for (or configured to be compiled to be used for) mapping and/or navigation-related services, such as for personalized route determination, according to exemplary embodiments. For example, the geographic database 111 includes node data records 403, road segment or link data records 405, POI data records 407, radio generated POI records 409, and other data records 411, for example. More, fewer or different data records can be provided. In one embodiment, the other data records 411 include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example.

In exemplary embodiments, the road segment data records 405 are links or segments representing roads, streets, or paths, as can be used in the calculated route or recorded route information for determination of one or more personalized routes, according to exemplary embodiments. The node data records 403 are end points corresponding to the respective links or segments of the road segment data records 405. The road link data records 405 and the node data records 403 represent a road network, such as used by vehicles, cars, and/or other entities. Alternatively, the geographic database 111 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 111 can include data about the POIs and their respective locations in the POI data records 407. The geographic database 111 can also include data about places, such as cities, towns, or other communities, and other geographic features, such as bodies of water, mountain ranges, etc. Such place or feature data can be part of the POI data records 407 or can be associated with POIs or POI data records 407 (such as a data point used for displaying or representing a position of a city). In addition, the geographic database 111 can include data from radio advertisements associated with the POI data records 407 and their respective locations in the radio generated POI records 409. By way of example, the point of interest is extracted from the broadcasted point of interest information (e.g., radio advertisement, etc.) according to the various embodiments described herein.

The geographic database 111 can be maintained by the content provider in association with the services platform 113 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database 111 or data in the master geographic database 111 can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a UE 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

As mentioned above, the geographic database 111 can be a master geographic database, but in alternate embodiments, the geographic database 111 can represent a compiled navigation database that can be used in or with end user devices (e.g., UEs 101) to provided navigation-related functions. For example, the geographic database 111 can be used with the end user device 101 to provide an end user with navigation features. In such a case, the geographic database 111 can be downloaded or stored on the end user device UE 101, such as in applications 103, or the end user device UE 101 can access the geographic database 111 through a wireless or wired connection (such as via a server and/or the communication network 107), for example.

In one embodiment, the end user device or UE 101 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the navigation device UE 101 can be a cellular telephone. An end user can use the device UE 101 for navigation functions such as guidance and map display, for example, and for determination of one or more personalized routes or route segments based on one or more calculated and recorded routes, according to exemplary embodiments.

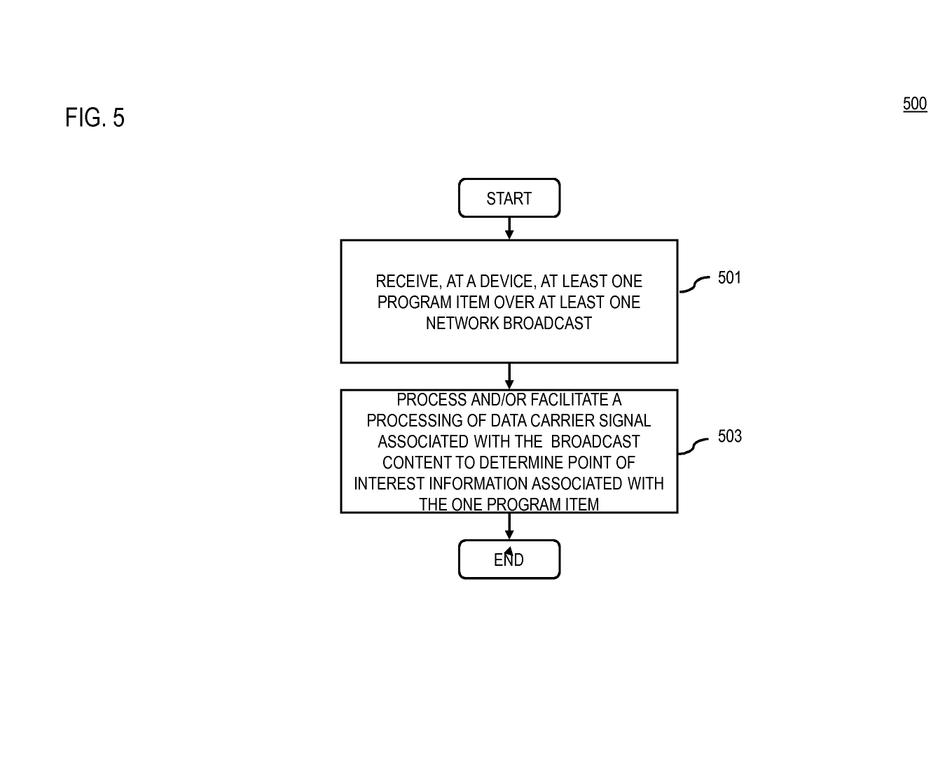

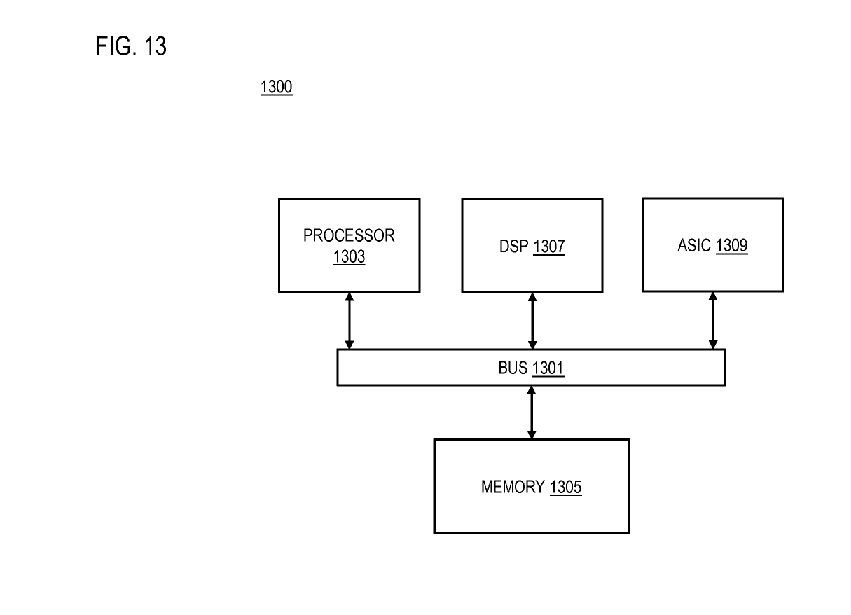

FIG. 5 is a flowchart of a process for receiving a program item over a network broadcast and processing and/or facilitating a processing of data carrier signal associated with the broadcast content to determine a point of interest information, according to one embodiment. In one embodiment, the point of interest platform performs the process 500 and is implemented in, for instance, a chip set including a processor and a memory as shown in FIG. 13.

In step 501, a mobile communication device receives at least one program item over at least one network broadcast. In one embodiment, increasing number of people are using map based services hence numerous companies are providing hyper local point of interest data to the users of UE 101. The data carrier signal received is based, at least in part, on a Radio Data System (RDS) protocol and/or a Radio Broadcast Data System (RBDS) protocol. According to one embodiment of the present invention, a mobile communication device is equipped with a tunable RDS and/or RDBS FM transmitter. The user of the mobile communication device chooses an FM frequency, the user then tunes the transmitter to the chosen frequency. The mobile communication device then receives the tuned in FM signal and the user can listen to the program item over the network broadcast.

In step 503, a mobile communication device upon receiving a program item over a network broadcast may request the point of interest platform 109 to process the data carrier signal associated with the network broadcast to determine point of interest information associated with the program item. A point of interest information may contain latitude coordinates, longitude coordinates, shop name, address, contact information etc. Such point of data is many time augmented with special deals or coupons, however the main challenge for any location based service is how to reach the user and give them access to relevant point of interest information. In one embodiment, the point of interest platform 109 may process user content and/or contextual information (e.g., user preference information, user profile information, location information etc.) associated with UE 101 to determine point of interest information associated with the received program item. In one scenario, the point of interest platform 109 may determine a point of interest information based, at least in part, on historical user information, such as, the number of times a particular location was visited by the user of UE 101.

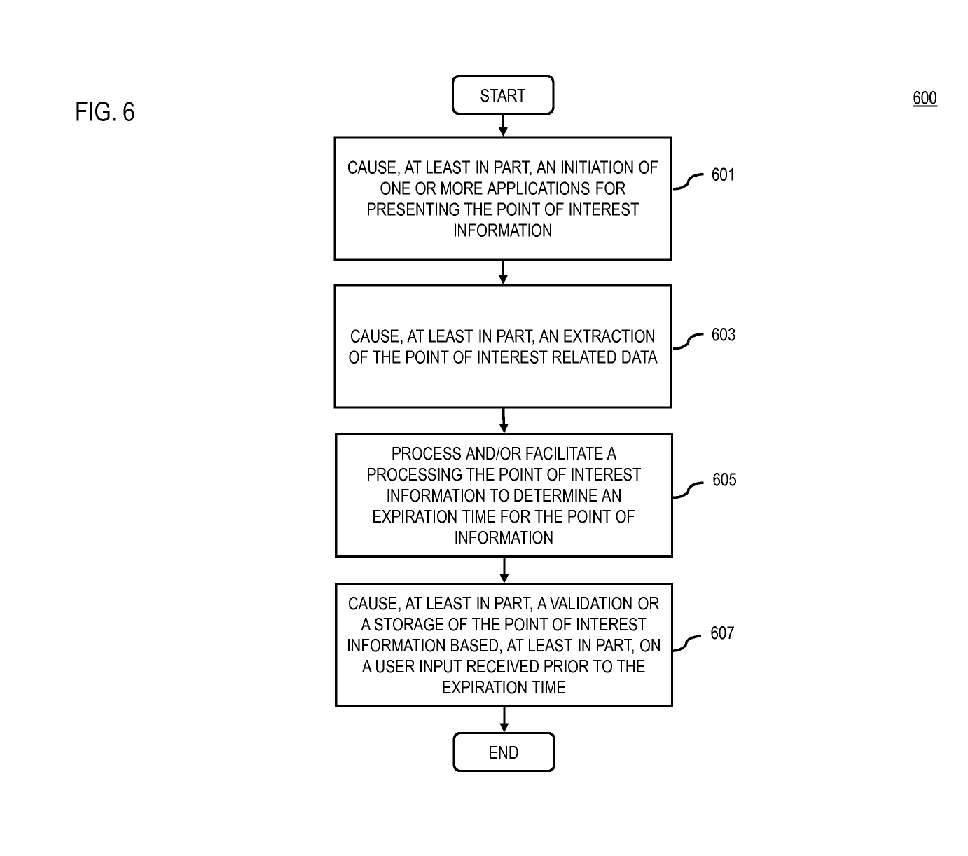

FIG. 6 is a flowchart of a process for presenting the point of interest information, determining an expiration time for the point of interest, and then causing a validation or storage of the point of interest information, according to one embodiment. In one embodiment, the point of interest platform performs the process 600 and is implemented in, for instance, a chip set including a processor and a memory as shown in FIG. 13.

In step 601, for instance, the point of interest platform 109 causes an initiation of one or more applications for presenting the determined point of interest information. For the purpose of the presentation, the point of interest information is transmitted in a map readable format, wherein the one or more applications include, at least in part, a mapping application and/or a navigation application and/or a location-based application. The point of interest information is then plotted on a mapping user interface. In one scenario, one problem with radio program broadcasts is the listeners often fail to hear all information, for example if the listener is carrying out another task as well as listening, if the reception is poor or if the information is detailed and complex. Therefore, when an aural advertisement is played, the point of interest information of the advertisement is broadcasted using radio data services, for instance, “50% off on XYZ restaurant, visit XYZ restaurant on 1765 street”. Instead of just audio advertisement, the point of interest information is transmitted in map readable format, which is plotted on the mapping device, which may be saved for future reference. This makes radio advertisement more effective since the information is not lost, and is actually stored in user's mobile communication device. In addition to this, the point of interest information could also be shared in user's social network.

In step 603, the point of interest platform causes, at least in part, an extraction of the point of interest related data. The point of interest platform may extract the point of interest information from a broadcast content based on the content information of the one or more UE 101 associated with the point of interest platform 109, which are determined once the content information is processed.

In step 605, the point of interest platform 109 processes and/or facilitates a processing of the point of interest information to determine an expiration time for the point of interest information. In one scenario, for instance, when an aural advertisement is broadcasted, for instance, “50% off on XYZ restaurant, visit XYZ restaurant on 1765 street, offer open for 5 days”. The point of interest platform 109 processes the point of interest information to determine the duration for the point of interest information. Such information is useless after 5 days, hence the point of interest platform 109 may delete the information five days after the advertisement was broadcasted.

In step 607, the point of interest platform 109 causes a validation or a storage of the point of interest information based, at least in part, on a user input received prior to the expiration time. In one scenario, when an aural advertisement is broadcasted, for instance, “XYZ new opening hours M-F 13:00-18:00, Sa and Su closed”, the point of interest platform 109 may process and determine such point of interest information and then plot the information in the mapping device.

The point of interest platform 109 may request the user for their input on the point of interest information and may cause a validation or storage of the information based on the input, even though the determined duration for the point of interest information has been exceeded. Hence, giving the user the liberty to manage the information.

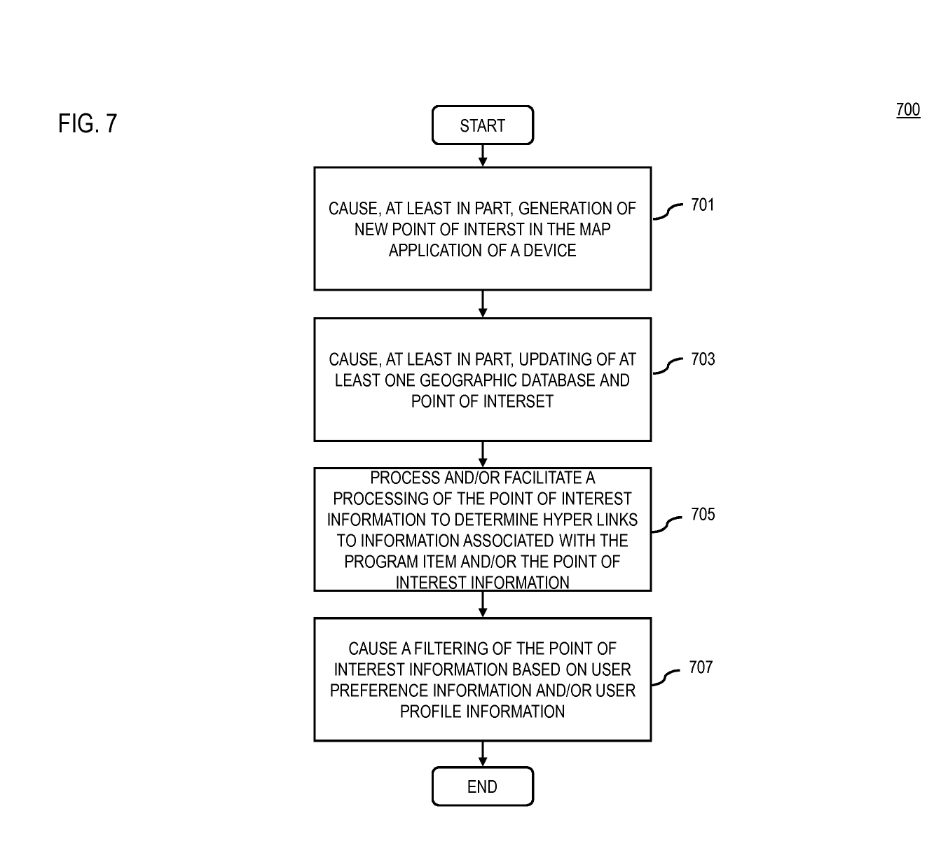

FIG. 7 is a flowchart of a process for causing an update of at least one geographic database and point of interest, determining one or more hyper links to information associated with the program item, and causing a filtering of the point of interest information, according to one embodiment. In one embodiment, the abstraction platform performs the process 700 and is implemented in, for instance, a chip set including a processor and a memory as shown in FIG. 13.

In step 701, the point of interest platform 109 causes a generation of a new point of interest in a map application of a device. In one scenario, for instance, a UE 101 receives a program item over a network broadcast, subsequently the point of interest platform 109 may process such data carrier signal associated with the broadcast content to determine point of interest information associated with the at least one program item. The determined point of interest information is used to generate a new point of interest, which is transmitted in a map readable format as a presentation to the user.

In step 703, the point of interest platform 109 causes, at least in part, an updating of at least one geographic database and point of interest associated with the device based, at least in part, on the point of interest information. In one scenario, a point of interest has shifted to a new location, therefore the point of interest platform 109 may update the location information about the point of interest because the point of interest is relevant for the user of UE 101. The point of interest platform 109 makes such determination by processing the user profile information and/or user preference information and/or contextual information etc. The point of interest platform 109 may replace the old point of interest information with updated point of interest. Such updates are important to ensure that the information provided is correct.

In step 705, the point of interest platform 109 processes and/or facilitates a processing of the point of interest information to determine one or more hyper links to information associated with the at least one program item, the point of interest information, or a combination thereof.

In step 707, the point of interest platform 109 causes, at least in part, a filtering of the point of interest information based, at least in part, on user preference information, user profile information, or a combination thereof. In one scenario, the user of UE 101 has shifted to a new location, therefore the point of interest platform 109 may not display point of interest information relating to the old location. The point of interest platform 109 may generate new point of interest information based on user preference information and/or user profile information. The point of interest platform 109 may use this information to filter the point of interest information and not include those point of interest information that may not be relevant to the user of the UE 101.

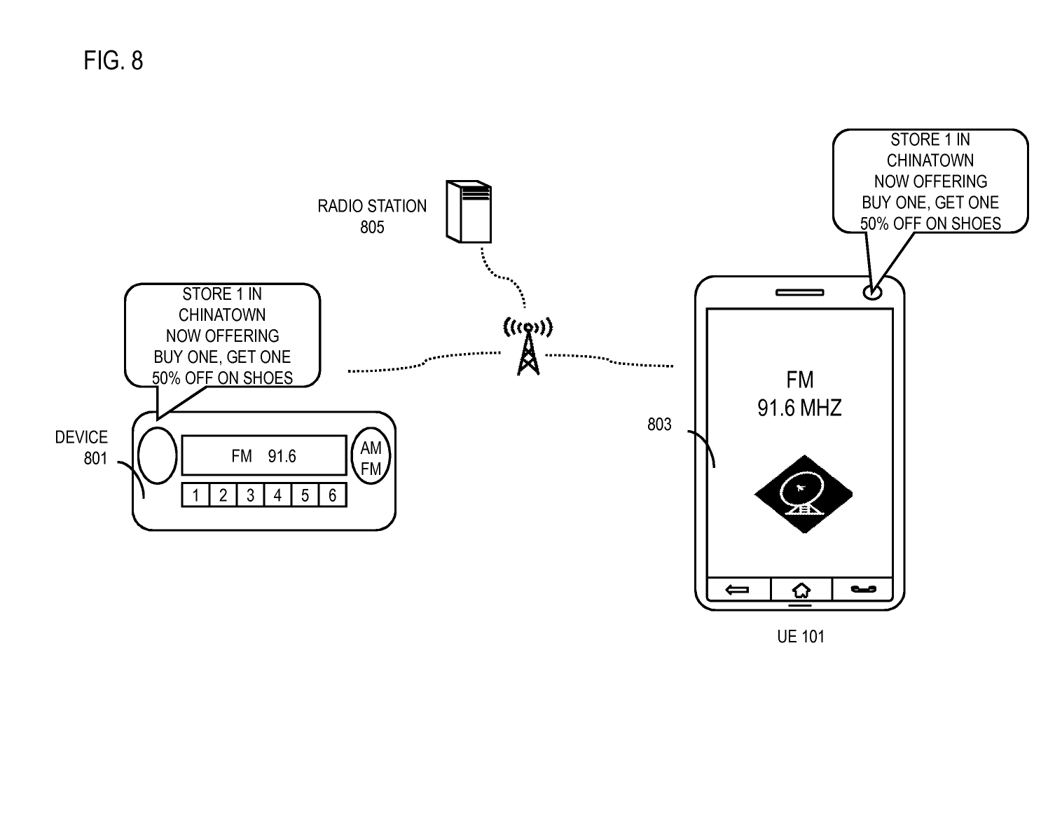

FIG. 8 is a diagram of user interfaces utilized in the processes of FIGS. 5-7, according to various embodiments. For example, FIG. 8 illustrates a method for network broadcast of one or more point of interest information which is received by device 801 and UE 101. In one scenario, network broadcast originates at the broadcast source (radio station 805). The radio station 805 sends out their broadcast signal, wherein the at least one data carrier signal is based, at least in part, on Radio Data System (RDS) protocol and/or a Radio Broadcast Data System (RBDS) protocol. The aim of these protocols is the instant and unique identification of the radio stations in order to help the listener to find his way in the over-burdened radio band. The broadcast signals are sent out at a frequency that can be detected by the device 801 and UE 101. Both device 801 and UE 101 receives the broadcast content that “store 1 in china town is now offering buy one, get one 50% off on shoes”.

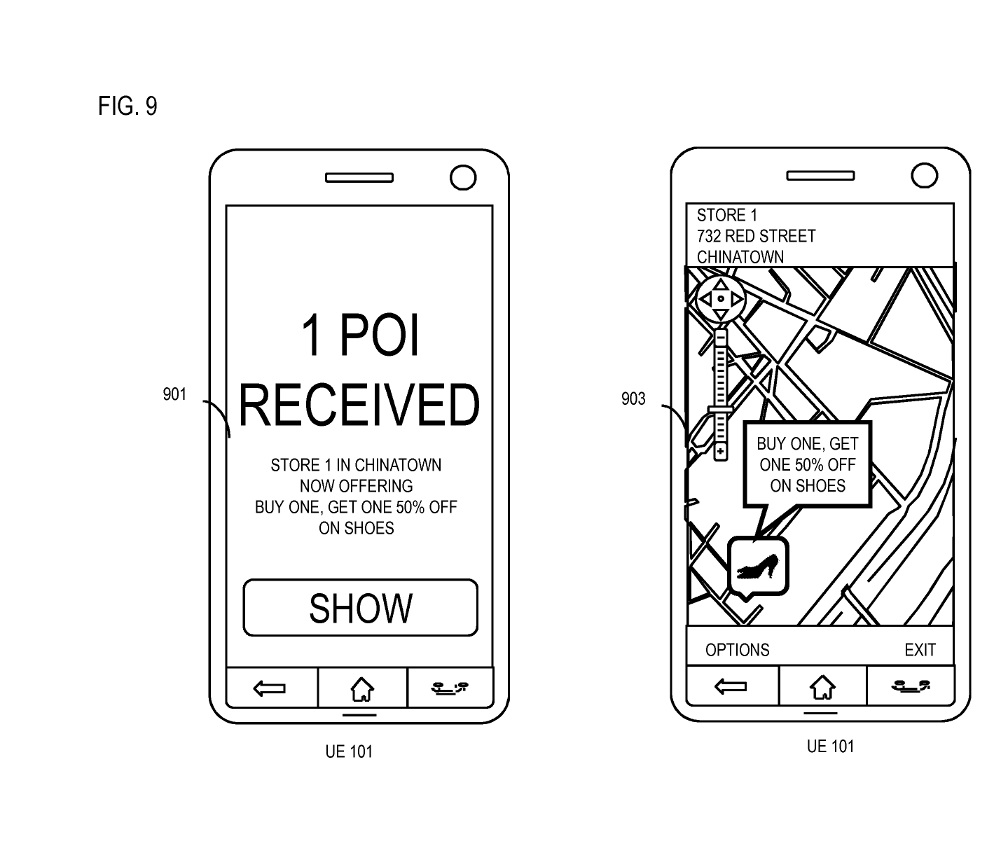

FIG. 9 is a diagram of user interfaces utilized in the processes of FIGS. 5-7, according to various embodiments. As illustrated, the UE 101 receives a program item (depicted in interface 901), the text announcement as it is nowadays can be shown as text with new function. The UE 101 then sends a transmission request to the point of interest platform 109. The point of interest platform 109 then communicates with several services, such as the services 115 and/or content providers 117, for user preference information and user profile information. The point of interest platform 109 finds the user information associated with the point of interest and processes them, for instance, the point of interest platform 109 finds the historical user information, proximity information etc. The point of interest platform 109 then processes and/or facilitates a processing of at least one data carrier signal associated with the at least one broadcast content to determine point of interest information associated with the at least one program item. Upon determination of the point of interest information, the text is forwarded to map application to the relevant point of interest on the map. The point of interest platform 109 may cause an initiation of one or more applications for presenting the point of interest information, wherein the point of interest information is transmitted in a map readable format and then plotted on a mapping user interface. The “Store 1 in Chinatown” information may trigger opening of map application, or may be stored for later use, when user is active with the point of interest. The interface 903 of UE 101 displays the presentation of the one or more point of interest information as visual guidance information for locating the point of interests, wherein the text is displayed with the map accordingly. The user may get the point of interest information by clicking on the Store 1 icon or selecting from options. Such presentation provides the user with an idea of the direction of point of interests and he can easily spot the point of interests by relating the map representation with real life spaces, for instance, how far Store 1 is from his current location? How long it may take the user to reach Store 1? etc.

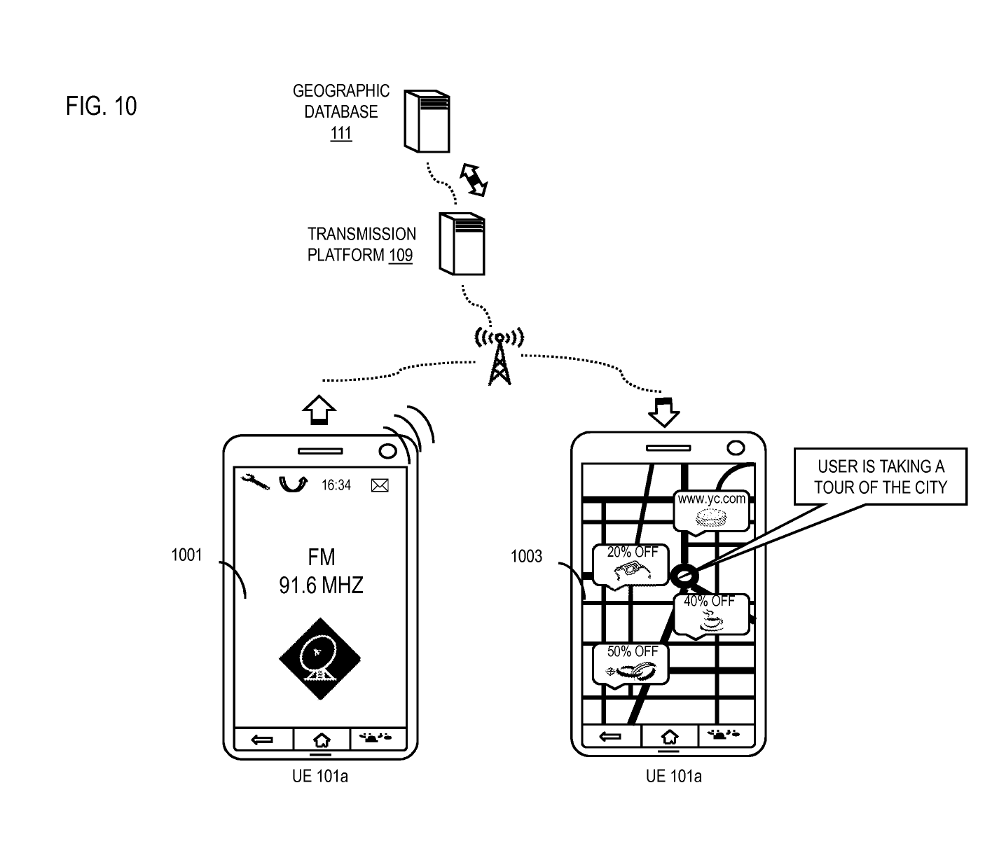

FIG. 10 is a diagram of user interfaces utilized in the processes of FIGS. 5-7, according to various embodiments. As illustrated, UE 101a have interfaces 1001 and 1003, respectively. The user interface 1001 shows a receiving by UE 101 a broadcast content, and UE 101 sending a request to the point of interest platform 109 for processing the point of interest information. The user interface 1003 shows one embodiment which depicts the presentation of the point of interest in combination with embedded textual data (point of interest information). For example, such textual data can be the name of the destination for easy identification or any other attributes of the point of interest (e.g., the discount offered, hyperlink, etc.). As part of the visualization of user interface 1003, four point of interest information are displayed, such presentation may be based, at least in part, on contextual information, such as historical user information, predicted user information, location proximity information, temporal proximity information, contextual proximity information, user preference information etc. The visual presentation can be of any kind of theme, as long as it is represented with the point of interest. In another example, the user of UE 101 plans a trip around the city XYZ, a new destination, and user interface 1003 may display presentations of the point of interest information based, at least in part, on popularity of the destination and/or user contextual information. Hence, the user can easily identify and associate the point of interest information with the point of interest, and plan the route for the trip accordingly.

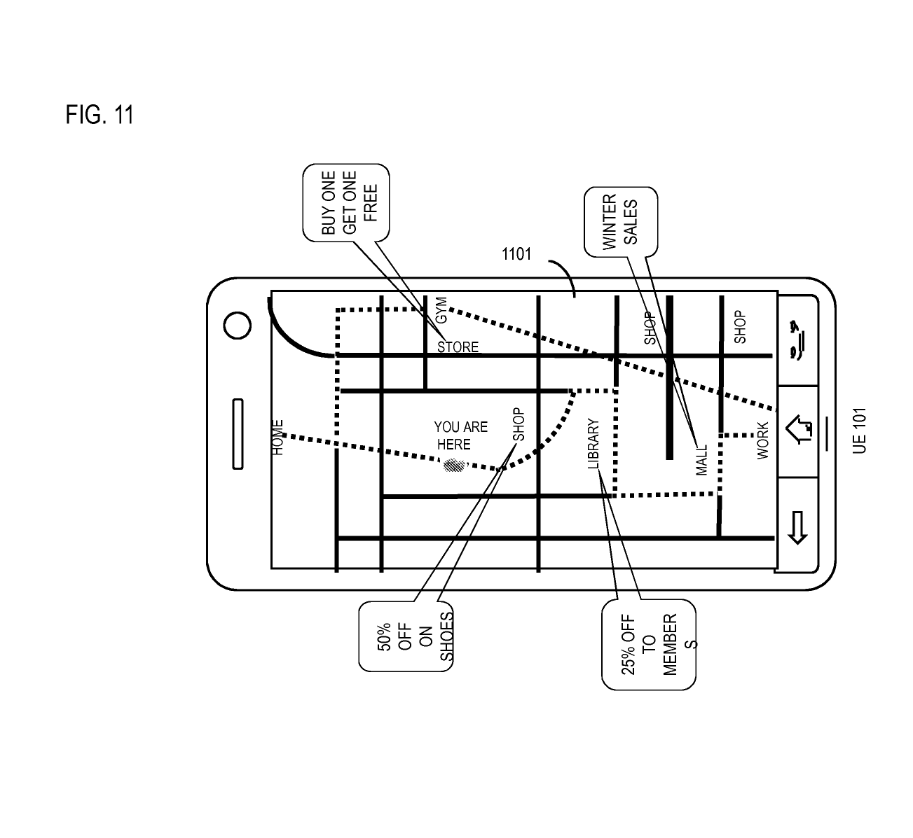

FIG. 11 is a diagram of user interfaces utilized in the processes of FIGS. 5-7, according to various embodiments. As illustrated, the UE 101 upon receiving a program item over a network broadcast sends a request to the point of interest platform 109 for processing of the data carrier signal associated with the at least one network broadcast to determine point of interest information associated with the at least one program item. The point of interest platform may communicate with geographic database 111 to determine a point of interest information. The point of interest platform may then filter the point of interest information based, at least in part, on user preference information, user profile information, or a combination thereof. As illustrated, UE 101 has an interface that displays point of interest information for those point of interest that may be determined by the point of interest platform 109 as relevant in terms of the user of the UE 101. In the example, the user of UE 101 drives the same route on weekdays, this travel routine is saved in the location database 111. The point of interest platform 109 may use this information to filter the point of interest information and not include those point of interest information that may not be relevant to the user of the UE 101.

The processes described herein for processing a data carrier signal associated with a network broadcast to determine point of interest information, and transmit the determined point of interest information in a map readable format, where it is presented with the linked point of interest as visual guidance information to users may be advantageously implemented via software, hardware, firmware or a combination of software and/or firmware and/or hardware. For example, the processes described herein, may be advantageously implemented via processor(s),

Digital Signal Processing (DSP) chip, an Application Specific Integrated Circuit (ASIC), Field Programmable Gate Arrays (FPGAs), etc. Such exemplary hardware for performing the described functions is detailed below.

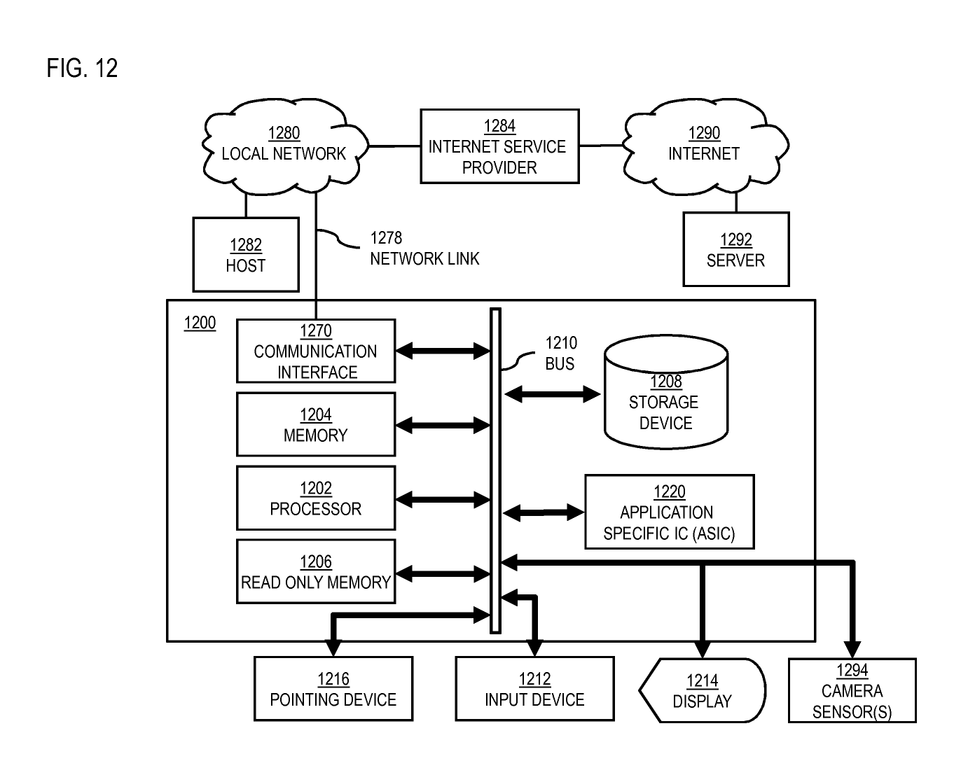

FIG. 12 illustrates a computer system 1200 upon which an embodiment of the invention may be implemented. Although computer system 1200 is depicted with respect to a particular device or equipment, it is contemplated that other devices or equipment (e.g., network elements, servers, etc.) within FIG. 12 can deploy the illustrated hardware and components of system 1200. Computer system 1200 is programmed (e.g., via computer program code or instructions) to process a data carrier signal associated with a network broadcast to determine point of interest information, and transmit the determined point of interest information in a map readable format, where it is presented with the linked point of interest as visual guidance information to users, as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1200, or a portion thereof, constitutes a means for performing one or more steps of processing a data carrier signal associated with a network broadcast to determine point of interest information, and transmit the determined point of interest information in a map readable format, where it is presented with the linked point of interest as visual guidance information to users.

A bus 1210 includes one or more parallel conductors of information so that information is transferred quickly among devices coupled to the bus 1210. One or more processors 1202 for processing information are coupled with the bus 1210.

A processor (or multiple processors) 1202 performs a set of operations on information as specified by computer program code related to processing a data carrier signal associated with a network broadcast to determine point of interest information, and transmit the determined point of interest information in a map readable format, where it is presented with the linked point of interest as visual guidance information to users. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1200 also includes a memory 1204 coupled to bus 1210. The memory 1204, such as a random access memory (RAM) or any other dynamic storage device, stores information including processor instructions for processing a data carrier signal associated with a network broadcast to determine point of interest information, and transmit the determined point of interest information in a map readable format, where it is presented with the linked point of interest as visual guidance information to users. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or any other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions for processing a data carrier signal associated with a network broadcast to determine point of interest information, and transmit the determined point of interest information in a map readable format, where it is presented with the linked point of interest as visual guidance information to users, is provided to the bus 1210 for use by the processor from an external input device 1212, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT), a liquid crystal display (LCD), a light emitting diode (LED) display, an organic LED (OLED) display, a plasma screen, or a printer for presenting text or images, and a pointing device 1216, such as a mouse, a trackball, cursor direction keys, or a motion sensor, for controlling a position of a small cursor image presented on the display 1214 and issuing commands associated with graphical elements presented on the display 1214, and one or more camera sensors 1294 for capturing, recording and causing to store one or more still and/or moving images (e.g., videos, movies, etc.) which also may comprise audio recordings. In some embodiments, for example, in embodiments in which the computer system 1200 performs all functions automatically without human input, one or more of external input device 1212, display device 1214 and pointing device 1216 may be omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of ASICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection to the communication network 105 for processing a data carrier signal associated with a network broadcast to determine point of interest information, and transmit the determined point of interest information in a map readable format, where it is presented with the linked point of interest as visual guidance information to users of UE 101.

The term “computer-readable medium” as used herein refers to any medium that participates in providing information to processor 1202, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1208. Volatile media include, for example, dynamic memory 1204. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1220.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290.

A computer called a server host 1292 connected to the Internet hosts a process that provides a service in response to information received over the Internet. For example, server host 1292 hosts a process that provides information representing video data for presentation at display 1214. It is contemplated that the components of system 1200 can be deployed in various configurations within other computer systems, e.g., host 1282 and server 1292.

At least some embodiments of the invention are related to the use of computer system 1200 for implementing some or all of the techniques described herein. According to one embodiment of the invention, those techniques are performed by computer system 1200 in response to processor 1202 executing one or more sequences of one or more processor instructions contained in memory 1204. Such instructions, also called computer instructions, software and program code, may be read into memory 1204 from another computer-readable medium such as storage device 1208 or network link 1278. Execution of the sequences of instructions contained in memory 1204 causes processor 1202 to perform one or more of the method steps described herein. In alternative embodiments, hardware, such as ASIC 1220, may be used in place of or in combination with software to implement the invention. Thus, embodiments of the invention are not limited to any specific combination of hardware and software, unless otherwise explicitly stated herein.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server host 1292 transmits program code for a particular application, requested by a message sent from computer 1200, through Internet 1290, ISP equipment 1284, local network 1280 and communications interface 1270. The received code may be executed by processor 1202 as it is received, or may be stored in memory 1204 or in storage device 1208 or any other non-volatile storage for later execution, or both. In this manner, computer system 1200 may obtain application program code in the form of signals on a carrier wave.

Various forms of computer readable media may be involved in carrying one or more sequence of instructions or data or both to processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red carrier wave serving as the network link 1278. An infrared detector serving as communications interface 1270 receives the instructions and data carried in the infrared signal and places information representing the instructions and data onto bus 1210. Bus 1210 carries the information to memory 1204 from which processor 1202 retrieves and executes the instructions using some of the data sent with the instructions. The instructions and data received in memory 1204 may optionally be stored on storage device 1208, either before or after execution by the processor 1202.

FIG. 13 illustrates a chip set or chip 1300 upon which an embodiment of the invention may be implemented. Chip set 1300 is programmed to process a data carrier signal associated with a network broadcast to determine point of interest information, and transmit the determined point of interest information in a map readable format, where it is presented with the linked point of interest as visual guidance information to users as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1300 can be implemented in a single chip. It is further contemplated that in certain embodiments the chip set or chip 1300 can be implemented as a single “system on a chip.” It is further contemplated that in certain embodiments a separate ASIC would not be used, for example, and that all relevant functions as disclosed herein would be performed by a processor or processors. Chip set or chip 1300, or a portion thereof, constitutes a means for performing one or more steps of providing user interface navigation information associated with the availability of functions. Chip set or chip 1300, or a portion thereof, constitutes a means for performing one or more steps of processing a data carrier signal associated with a network broadcast to determine point of interest information, and transmit the determined point of interest information in a map readable format, where it is presented with the linked point of interest as visual guidance information to users.

In one embodiment, the chip set or chip 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1300 includes merely one or more processors and some software and/or firmware supporting and/or relating to and/or for the one or more processors.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to process a data carrier signal associated with a network broadcast to determine point of interest information, and transmit the determined point of interest information in a map readable format, where it is presented with the linked point of interest as visual guidance information to users. The memory 1305 also stores the data associated with or generated by the execution of the inventive steps.

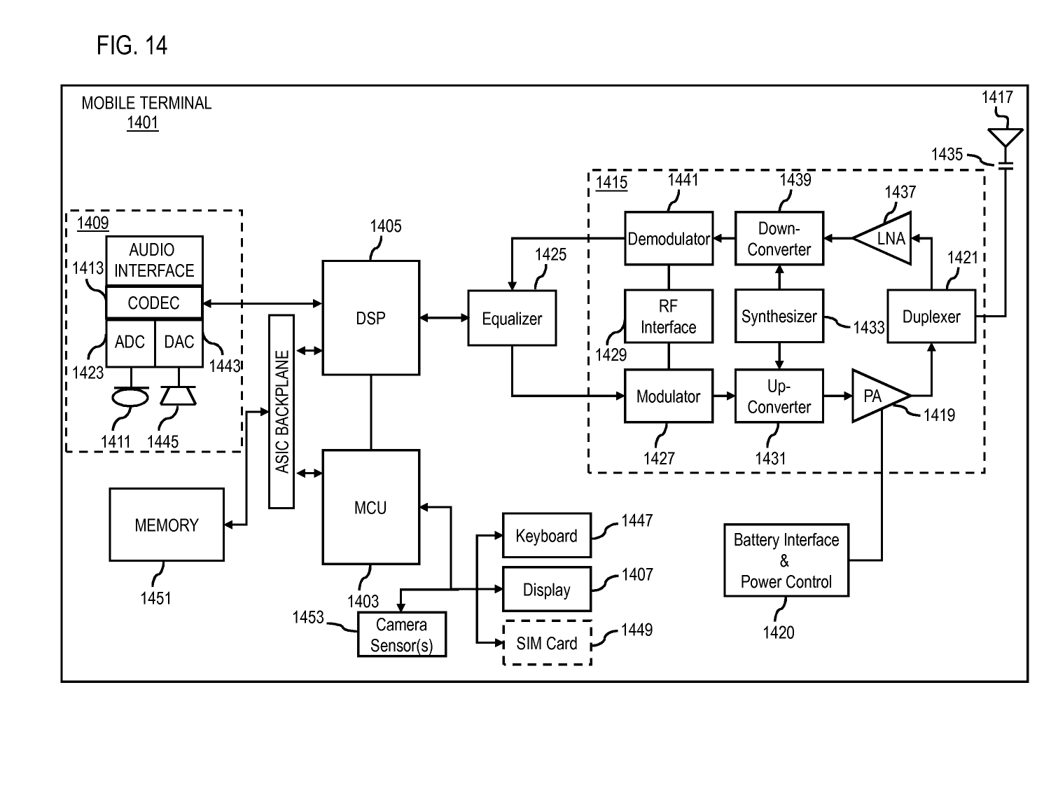

FIG. 14 is a diagram of exemplary components of a mobile terminal (e.g., handset) for communications, which is capable of operating in the system of FIG. 1, according to one embodiment. In some embodiments, mobile terminal 1401, or a portion thereof, constitutes a means for performing one or more steps of processing a data carrier signal associated with a network broadcast to determine point of interest information, and transmit the determined point of interest information in a map readable format, where it is presented with the linked point of interest as visual guidance information to users. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile terminal functions that perform or support the steps of processing a data carrier signal associated with a network broadcast to determine point of interest information, and transmit the determined point of interest information in a map readable format, where it is presented with the linked point of interest as visual guidance information to users. The display 1407 includes display circuitry configured to display at least a portion of a user interface of the mobile terminal (e.g., mobile telephone). Additionally, the display 1407 and display circuitry are configured to facilitate user control of at least some functions of the mobile terminal An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile terminal 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1425 for compensation of any frequency-dependent impairments that occur during transmission though the air such as phase and amplitude distortion. After equalizing the bit stream, the modulator 1427 combines the signal with a RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403 which can be implemented as a Central Processing Unit (CPU).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile terminal 1401 to process a data carrier signal associated with a network broadcast to determine point of interest information, and transmit the determined point of interest information in a map readable format, where it is presented with the linked point of interest as visual guidance information to users. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the terminal. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile terminal 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable storage medium known in the art. The memory device 1451 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1449 carries, for instance, important information, such as the cellular phone number, the carrier supplying service, subscription details, and security information. The SIM card 1449 serves primarily to identify the mobile terminal 1401 on a radio network. The card 1449 also contains a memory for storing a personal telephone number registry, text messages, and user specific mobile terminal settings.

Further, one or more camera sensors 1453 may be incorporated onto the mobile station 1401 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-38. (canceled)

39. An apparatus comprising:
at least one processor; and
at least one memory including computer program code for one or more programs,
the at least one memory and the computer program code configured to, with the at least one processor, cause the apparatus to perform at least the following,
receive, at a device, at least one program item over at least one network broadcast; and
process and/or facilitate a processing of at least one data carrier signal associated with the at least one broadcast content to determine point of interest information associated with the at least one program item.

40. An apparatus of claim 39, wherein the at least one data carrier signal is based, at least in part, on a Radio Data System (RDS) protocol, a Radio Broadcast Data System (RBDS) protocol, or a combination thereof.

41. An apparatus of claim 39, wherein the apparatus is further caused to:
cause, at least in part, an initiation of one or more applications for presenting the point of interest information, and
cause, at least in part, an extraction of the point of interest related data.

42. An apparatus of claim 41, wherein the point of interest information is transmitted in a map readable format, and wherein the one or more applications include, at least in part, a mapping application, a navigation application, a location-based application, or a combination thereof.

43. An apparatus of claim 42, wherein the presenting of the point of interest information comprises causing, at least in part, a plotting of the point of interest information on a mapping user interface.

44. An apparatus of claim 39, wherein the apparatus is further caused to:
process and/or facilitate a processing of the point of interest information to determine an expiration time for the point of interest information.

45. An apparatus of claim 44, wherein the apparatus is further caused to:
cause, at least in part, a validation or a storage of the point of interest information based, at least in part, on a user input received prior to the expiration time.

46. An apparatus of claim 39, wherein the apparatus is further caused to:
cause, at least in part, a generation of the new point of interest in the map application of a device; and
cause, at least in part, an updating of at least one geographic database and at least one expired point of interest by replacing with the latest point of interest based, at least in part, on the point of interest information.

47. An apparatus of claim 39, wherein the apparatus is further caused to:
process and/or facilitate a processing of the point of interest information to determine one or more hyper links to information associated with the at least one program item, the point of interest information, or a combination thereof.

48. A method comprising:
receiving, at a device, at least one program item over at least one network broadcast; and
processing and/or facilitating a processing of at least one data carrier signal associated with the at least one broadcast content to determine point of interest information associated with the at least one program item.

49. A method of claim 48, wherein the at least one data carrier signal is based, at least in part, on a Radio Data System (RDS) protocol, a Radio Broadcast Data System (RBDS) protocol, or a combination thereof.

50. A method of claim 48, further comprising:
causing, at least in part, an initiation of one or more applications for presenting the point of interest information, and
causing, at least in part, an extraction of the point of interest related data.

51. A method of claim 50, wherein the point of interest information is transmitted in a map readable format, and wherein the one or more applications include, at least in part, a mapping application, a navigation application, a location-based application, or a combination thereof.

52. A method of claim 51, wherein the presenting of the point of interest information comprises causing, at least in part, a plotting of the point of interest information on a mapping user interface.

53. A method of claim 48, further comprising:
processing and/or facilitating a processing of the point of interest information to determine an expiration time for the point of interest information.

54. A method of claim 53, further comprising:
causing, at least in part, a validation or a storage of the point of interest information based, at least in part, on a user input received prior to the expiration time.

55. A method of claim 48, further comprising:
causing, at least in part, a generation of the new point of interest in the map application of a device; and
causing, at least in part, an updating of at least one geographic database and at least one expired point of interest by replacing with the latest point of interest based, at least in part, on the point of interest information.

56. A method of claim 48, further comprising:
processing and/or facilitating a processing of the point of interest information to determine one or more hyper links to information associated with the at least one program item, the point of interest information, or a combination thereof.

57. A computer program product including one or more sequences of one or more instructions which, when executed by one or more processors, cause an apparatus to at least perform the steps:
receiving, at a device, at least one program item over at least one network broadcast; and
processing and/or facilitating a processing of at least one data carrier signal associated with the at least one broadcast content to determine point of interest information associated with the at least one program item.

58. A computer program product of claim 57, wherein the at least one data carrier signal is based, at least in part, on a Radio Data System (RDS) protocol, a Radio Broadcast Data System (RBDS) protocol, or a combination thereof.
